(19) United States
(12) Patent Application Publication
(10) Pub. No.: US 2002/0034399 A1
(43) Pub. Date: Mar. 21, 2002

(54) Liquid developing device, method of it's maintenence and the method of recovery of supplemental fluid from the liquid developing device

(76) Inventors: Shogo Matsumoto, Ushiku (JP); Kazutaka Satou, Kashiwa (JP); Mieko Ishll, Tsuchiura (JP); Yoshio Ohuchi, Toukai (JP); Juichi Matsuno, Tsuchiura (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/810,570

(22) Filed: Mar. 19, 2001

(30) Foreign Application Priority Data
Sep. 19, 2000 (JP) 2000-284058

(51) Int. Cl. G03G 15/04

(52) U.S. Cl. 399/119

(57) ABSTRACT

Subject

In a liquid type development device, to improve the tractability of a liquid development cartridge; suppress user's tendency of casting away the remaining supplementary liquid; and improve user's witting of recycling the remaining supplementary liquid and the efficiency of recovering the remaining supplementary liquid: by using liquid developer of high concentration, whose evapotranspiration to the air is a little, and for which a recirculation device for controlling its concentration is not necessary; providing a cartridge including the liquid developer and supplementary liquid added to the liquid developer so as to keep the concentration of the liquid developer constant; memorizing the amount of supplementary liquid remaining in the cartridge; and giving a user a special privilege of a discount price for a new development cartridge corresponding to the remaining amount of supplementary liquid.

Means to Solve the Subject

A liquid type development device developing an electrostatic latent image formed on image-holding equipment by using liquid developer made of highly insulating solvent and toner particles dispersed in the solvent, comprises: a liquid developer tank detachably situated in a cartridge; and at least one supplementary liquid tank containing supplementary liquid to be added to liquid developer contained in the liquid developer tank so as to keep the concentration of nonvolatile components in the liquid developer constant. Further, when the used development cartridge is recovered, and another new development cartridge is bought, a discount price privilege for the newly bought development cartridge is given to a user who has brought the used cartridge with him.

### BACKGROUND OF THE INVENTION

The present invention relates to a liquid type development device for visualizing an electrostatic latent image which is formed by electronic photography, electrostatic recording, ionography, etc., using liquid developer, and especially relates to improving the easiness of maintenance and the use convenience of a development device in the liquid type development device.

Since toner of fine particles whose diameters are less than 1 μm can be used in a liquid type development device, a high-quality image which is faithfully developed to its electrostatic latent image can be obtained.

Liquid type development apparatuses using liquid developer are disclosed, for example, in Japanese Patent Application Laid-Open Hei 11-15280 and Japanese Patent Application Laid-Open Hei 8-137285.

In the liquid type development device disclosed in Japanese Patent Application Laid-Open Hei 11-15280, a developer-plenishing cartridge is filled with supplementary liquid developer along with high-pressure liquidized gas, and supplementary liquid developer is plenished to a developer-storing container for containing liquid developer by ejecting the supplementary liquid developer from the developer-plenishing cartridge when the plenishing of liquid developer becomes necessary. This developer-plenishing cartridge filled with supplementary liquid developer can be easily exchanged.

Further, the liquid type development device disclosed in Japanese Patent Application Laid-Open Hei 11-137285 includes a tube type container filled with liquid developer of high viscosity, in which toner is intensively dispersed in insulating liquid, a compressing device for extruding the liquid developer contained in the tube type container by squeezing out the liquid developer, and a development belt for holding and carrying the liquid developer extruded from the tube type container. Furthermore, the toner is fed to an electrostatic latent image on a photo conductor by bringing the development belt in contact with the photo conductor via the liquid developer. Moreover, since the liquid developer-storing means is implemented by the cartridge device, it is possible to plenish or exchange the liquid developer without contaminating user's hands.

In addition, techniques to improve the easiness of maintenance for a liquid type development device by detecting and memorizing the amount of liquid developer remaining in a cartridge, are disclosed in Japanese Patent Application Hei 8-224885 and Japanese Patent Application Hei 11-314375.

In the techniques disclosed in Japanese Patent Application Hei 8-224885 and Japanese Patent Application Hei 11-314375, an ID number is allocated to each ink cartridge, and the amount of ink remaining in the cartridge is detected and memorized. Accordingly, managing the amount of remaining ink is possible for each ink cartridge. Thus, even if an ink cartridge is exchanged with another one in mid-course, it is possible to have cleverly used up the ink remaining in the exchanged cartridge by attaching the cartridge again.

However, the above conventional techniques have the following problems.

That is, since the conventional liquid type development device has not a means for recovering liquid developer remaining in the liquid developer-storing device, and it is necessary to have cleverly used up the liquid developer in the liquid developer-storing device once liquid developer is fed to the liquid developer-storing device from a developer-plenishing cartridge, which in turn cause a problem of that much unused developer remains if only a few of copies is developed. Moreover, since the liquid developer-storing device is not sealed, liquid developer will be dried, and the dried developer will be deposited on a developer-holding device, which in turn deteriorates the quality of a developed image.

Further, in the conventional liquid type development devices, since liquid developer is directly fed to a developer-holding device from a developer-storing means, the developer-storing means must be precisely controlled, which in turn deteriorates the tractability of the liquid development apparatuses. Furthermore, maintenance of the development apparatuses is difficult if the developer-holding device is composed of multistage rollers, and liquid developer applied onto the developer-holding device is dried and deposited, which in turn deteriorates the quality of a developed image.

In addition, in the disclosed conventional techniques, since any technique for promoting the recycle of remaining liquid developer and its container has not been indicated, there is fear that increase of waste products have adverse effects on environment.

An objective of the present invention is to provide a liquid type development device which is capable of solving the above-described problems, a maintenance method of the liquid type development device, and a method of efficiently recovering unused and remaining supplementary liquid which is added so as to keep the concentration of liquid developer in the liquid type development device constant.

### SUMMARY OF THE INVENTION

To achieve the above objective, the present invention provides a liquid type development device for developing an electrostatic latent image formed on an image-holding device by using liquid developer made of highly insulating solvent and toner particles dispersed in the solvent, the development apparatus comprising: a liquid developer tank detachably situated in a cartridge; and at least one supplementary liquid tank containing supplementary liquid to be added to liquid developer contained in the liquid developer tank so as to keep the concentration of nonvolatile components in the liquid developer. Further, the cartridge in the development apparatus includes a memory device for memorizing the amount of supplementary liquid remaining in the supplementary liquid tank.

As described above, by setting the liquid developer tank and the supplementary liquid tank in the same cartridge, the number of parts which should receive maintenance can be reduced, and this improves the easiness of maintenance of the development apparatus. Further, by providing a means for memorizing the amount of remaining supplementary liquid, in the cartridge, since the cartridge is recycled by the unit of a cartridge when it is recycled, maintenance-managing of the development apparatus become easy, which in turn can improve the efficiency of recycling supplementary liquid.

Furthermore, by calculating a discount price of a newly bought cartridge, corresponding to the amount of the remaining supplementary liquid, user's tendency of casting away the remaining supplementary liquid can be suppressed, and user's witting of recycling the remaining supplementary liquid can be improved, which in turn can improve the efficiency of recovering remaining supplementary liquid.

Also, by increasing the above discount rate in phases corresponding to increase of the remaining supplementary liquid, the user's tendency of casing away the remaining supplementary liquid can be suppressed.

Moreover, by changing the amount of supplementary liquid fed to the liquid developer, corresponding to the print ratio, since the concentration of nonvolatile components in the liquid developer can be approximately kept constant, the development is stably continued.

Further, by preparing two kinds of supplementary liquid having different concentration levels of the nonvolatile components, that is, concentration levels higher and lower than that of the liquid developer, since the concentration of nonvolatile components in the liquid developer can be approximately kept constant even if an image of any print ratio is developed, the development is stably continued.

Furthermore, by providing an infiltration film at the boundary between liquid developer and supplementary liquid, since the concentration of the nonvolatile components in the liquid developer is kept constant by the action of the infiltration film, the concentration of the nonvolatile components in the liquid developer becomes more stable.

Moreover, in using a liquid type development device for developing an electrostatic latent image formed on an image-holding device by using liquid developer made of highly insulating solvent and toner particles dispersed in the solvent, by giving a discount price privilege to a user who has brought a used development device with him for recovery of the used development device, corresponding to the amount of supplementary liquid remaining in the development device, user's tendency of casting away the remaining supplementary liquid can be suppressed. In addition, user's witting of recycling the remaining supplementary liquid can also be improved, and the efficiency of recovering supplementary liquid which remains yet can be improved.

On top of that, by using liquid of developer including nonvolatile components of 1-30% concentration, since the amount of liquid developer fed to the image-holding device can be reduced, it is possible to simplify a developer-feeding means. Also, since the amount of necessary liquid developer becomes a little, the volume capacity of a liquid developer-storing means can be reduced, and this can downsize a liquid type development device, which in turn can decrease the size of a liquid type development device using the development device.

### BRIEF DESCRIPTION OF THE DRAWINGS

FIG. 1 is a schematic diagram showing the composition of an image printing apparatus using liquid developer of an embodiment according to the present invention.

FIG. 2 is a top view of a development unit of an embodiment according to the present invention.

FIG. 3 is a schematic block diagram showing the circuit composition of record equipment of an embodiment according to the present invention.

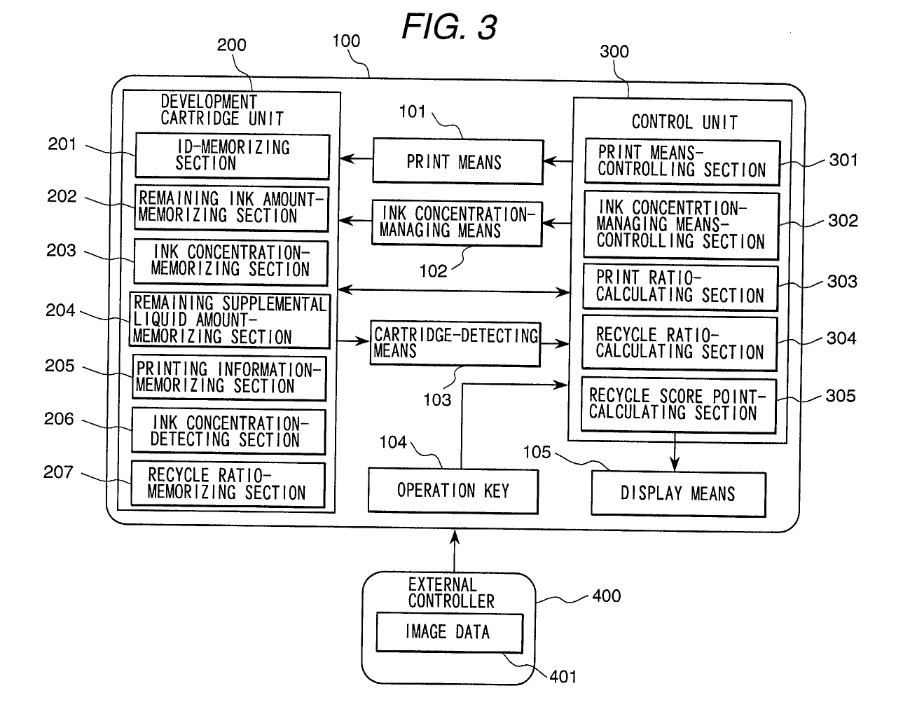

FIG. 4 is a schematic block diagram showing the circuit composition of a recovery means, which is used for recovering development cartridges, according to the present.

FIG. 5 is a perspective view of a recovery box implementing the recovery means according to the present invention.

FIG. 6 is a graph showing the relationship between the number of printed sheets and the concentration of nonvolatile components in ink after printing.

### DETAILED DESCRIPTION OF THE EMBODIMENTS

Hereafter, details of the embodiments will be explained with reference to the drawings.

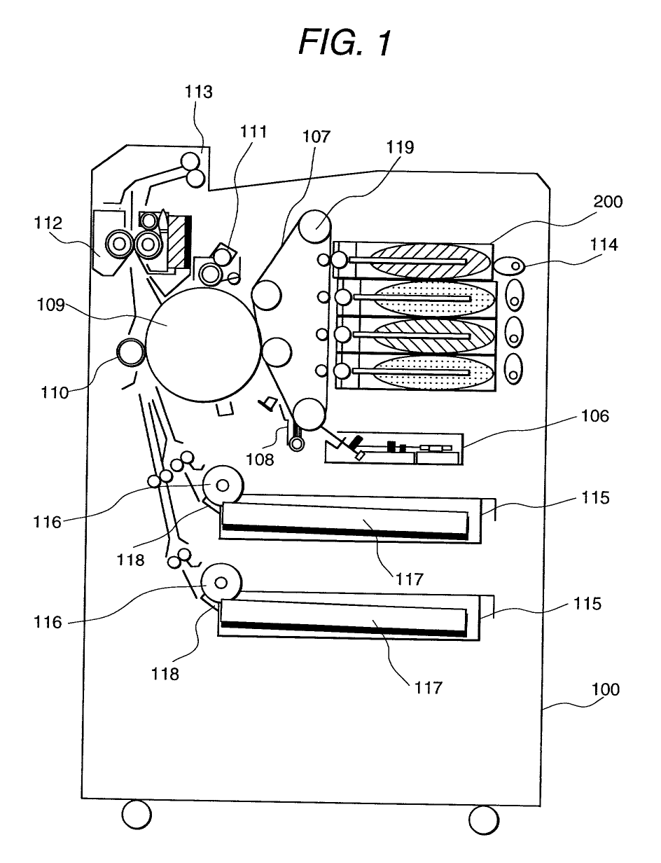

FIG. 1 schematically shows the composition of an image printing apparatus using liquid developer of an embodiment according to the present invention.

Paper sheets 117 are held in a paper sheet holder 115, and when an instruction to start printing is given, a sheet-feeding roller 116 takes out a paper sheet from the pager sheet holder 115 and carries the sheet while it rotates clockwise in this figure. Here, double feed of sheets is prevented from being carried all together by using a separation blade 118, this blade being situated at a middle point of the carrying route and being pressed to the sheet-feeding roller 116 by a predetermined quantity of pressing force.

A photo conductor belt 107 used as the image-holding device is wound around photo-conductor belt-moving rollers 119, and predetermined quantity of tensile force is given to the belt 107.

While the photo-conductor belt 107 is anticlockwise carried, its surface is uniformly electrized, and a laser optical system 106 further scans the surface of the belt 107 with a laser beam, corresponding to an image of each color, to form an electrostatic latent image. In this embodiment, since the surface potential of the sheet is controlled so that the polarity of the surface of the sheet is equal to that of toner particles, it becomes somewhat difficult for the toner particles to adhere to the sheet, and this can effectively prevent fog phenomena occurring in non-printed regions by liquid developer, which is a problem in the case of developing a latent image by using liquid developer of high concentration.

The photo conductor belt 107 is further carried, and the latent image formed on the belt 107 is visualized by a development cartridge 200 which functions as a developing means. In this embodiment, development units for four colors of yellow, magenta, cyan, and black, are provided, and the above-described developing processes are performed for each of the four colors. Further, the developed toner images for the respective colors are subscribed and superimposed on a intermediate transfer drum 109. Furthermore, after the superimposed toner image is transcribed from the surface of the intermediate transfer drum 109 onto the paper sheet 117 by a transfer roller 110, the transcribed toner image is fixed by a fixing device 112, and a full color image is obtained.

In this embodiment, there is a development unit cam 114 for moving a development cartridge 200 for each color right and left in FIG. 1, via an elastic development unit supporter 4. Further, a development cartridge 200 corresponding to a color for which a latent image is formed and developed, is selected and operated by moving the development cartridge 200 in the direction toward the photo conductor belt 107 while using a cam corresponding to the selected color. In this operation of the development cartridge 200, the gap between a development roller and the photo conductor belt 107 is controlled by a gap-adjusting mechanism (not shown diagrammatically).

Further, voltage such as that which causes an electric field between the development roller and the surface of the paper sheet, for moving toner particles in the direction toward the development roller, is applied to the development roller. Consequently, it becomes somewhat difficult for the toner particles to adhere to the sheet, and this can effectively prevent fog phenomena caused by liquid developer in non-printed regions, which becomes a problem in the case of developing a latent image by using liquid developer of high concentration.

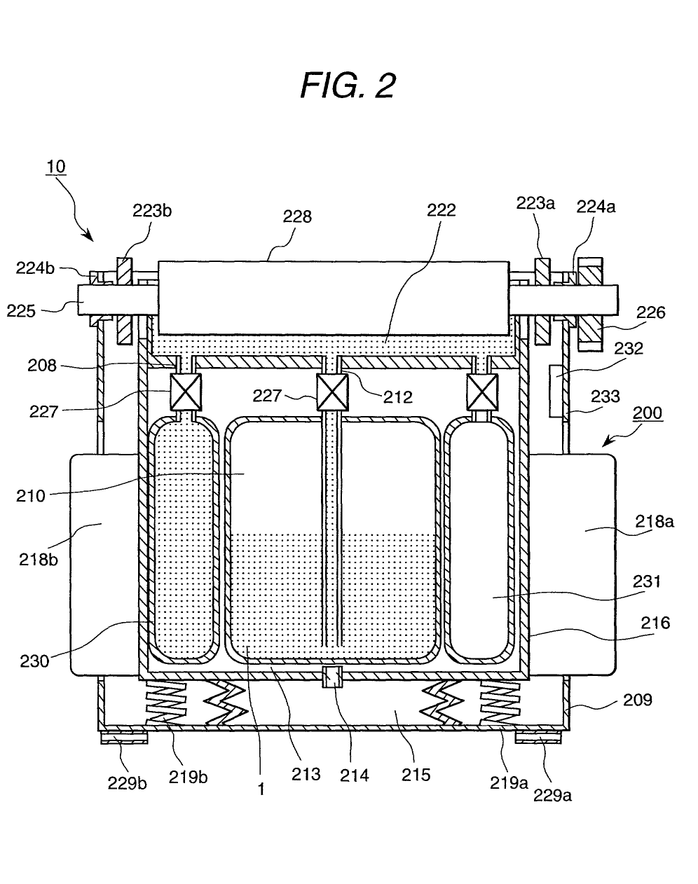

FIG. 2 shows a top view of the development unit for each color, of an embodiment according to the present invention.

This development unit 10 includes the detachable development cartridge 200, a liquid developer holder 222, and the development roller 228 immersed in the liquid developer held in the liquid developer holder 222. Meanwhile, the development roller 228 is not fully but partially immersed in the liquid developer.

The development roller 228 is rotatably supported at its shaft 225 by bearings 224a and 224b, and the bearings 224a and 224b are fixed to a development unit cover 209. Also, gap-keeping rolling bearings 223a and 223b are arranged at both end sides of the development roller 228. Further, while the photo-conductor belt (not shown in this figure) contacts these rolling bearings 223a and 223b, the gap is kept. Further, a gear 226 is attached to one end side of the development roller 228, and the driving force of a development roller-driving motor (not shown diagrammatically) is transmitted to the development roller 228 by the gear 226.

A liquid developer tank 210 containing liquid developer 1 is held in a pressure chamber 213 which is sealed from the outside air, and this pressure chamber 213 is further held in an inner chassis 216. Further, the liquid developer holder 222 is fixed in the inner chassis 216, and the liquid developer holder 222 communicates with the liquid developer tank 210 via a liquid developer-feed/recover pipe 212. Also, a check-valve 227 is connected to the liquid developer-feed/recover pipe 212. Thus, the direction of liquid developer flow is restricted from the liquid developer tank 210 toward the liquid developer holder 222 in the feed operation, and vice versa in the recovery operation. Further, the pressure chamber 213 communicates with a pressure generating chamber 215 via a pressure-transmitting pipe 214. The pressure-generating chamber 215 has a flexible structure such as that of a bellows type dropper, which is deformed by external force, and one end side of the pressure-generating chamber 215 is fixed to the inner chassis 216. Also, the other end side of the chamber 215 is fixed to a development unit cover 209 which is relatively movable to the inner chassis 216 (in the upper and lower direction in FIG. 2), and the pressure-generating chamber 215 is deformed by relatively moving the inner chassis 216 and the development unit cover 209 against the spring force of a return spring 219. The internal pressure of the pressure-generating chamber 215 changes due to the deformation of the chamber 215. Further, this pressure change is transmitted to the pressure chamber 213 via a pressure-transmitting pipe 214, and acts on the liquid developer tank 210. If the pressure-generating chamber 215 is compressed by the relative displacement between the inner chassis 216 and the development unit cover 209, the inside of the pressure chamber 213 is pressurized, and the liquid developer tank 210 is then compressed. Thus, the liquid developer 1 is fed to the liquid developer holder 222 via the liquid developer-feed/recover pipe 212. In this feed operation, a flow of the liquid developer and gas from the liquid developer tank 210 to the liquid developer holder 222 via a feed pipe 208 is prevented by the check-valve 227.

In this embodiment, the inner chassis 216 is fixed to the body of the development apparatus (not shown in FIG. 2), and the development unit cover 209 moves in the upper direction in FIG. 2 via elastic development-unit-supporters 229a and 229b, with the rotation of the development device cam (not shown in FIG. 2), and this movement compresses the pressure-generating chamber 2l5. Further,in this embodiment, the bearings of the development roller 228 is fixed to the development unit cover 209. Accordingly, the development roller 228 moves in the upper direction in FIG. 2 with the movement of the development unit cover 209, and is pressed to the paper sheet (not shown in FIG. 2). Gap-keeping rolling bearings 223 having an outer diameter larger by a predetermined quantity than that of the development roller 228, are arranged at this roller 228 so as to keep the gap between the photo conductor belt (not shown in FIG. 2) and the roller 228.

In the operation of finishing the developing, by rotating the development cam (not shown in FIG. 2) attached to the body of the development apparatus from the position at which the developing operation has been performed, the development unit cover 209 is moved in the lower direction in FIG. 2 by the spring force of the return spring 219. When the development unit cover 209 is moved in the lower direction in this figure, the development roller 228 whose bearings are fixed to the development unit cover 209, is also moved in the lower direction in this figure, and the development roller 228 is detached from the paper sheet (not shown in this figure). Thus, the developing operation is finished. In this embodiment, the shape of the inner face of the liquid developer holder 222 is cylindrical, and its diameter is almost equal to that of the outer face of the development roller 228. Further, if the development roller 228 is moved in the lower direction in FIG. 2 after the developing operation is finished, the development roller 3 closely contacts the inner face of the liquid developer holder 222, and this roller is held by the inner face of the holder 222. In the embodiments of the present invention, since the liquid developer is not open to the air, it is possible to prevent the deterioration of the liquid developer due to its evapotranspiration. Further, since the shape of the inner face of the liquid developer holder 222 is cylindrical, and its diameter is almost equal to that of the outer face of the development roller 228, it is possible to provide a wide contact face between the liquid developer holder 222 and the development roller 228, which in turn can improve the sealing performance at the contact face.

On the other hand, when the development unit cover 209 is moved in the lower direction in FIG. 2, the pressure-generating chamber 215 is expanded, and negative pressure is generated in the pressure chamber 213. Consequently, since the inside of the pressure chamber 213 is depressurized, and the liquid developer tank 210 is expanded due to the negative pressure, the liquid developer 1 in the liquid developer holder 222 is recovered into the liquid developer tank 210 via the liquid developer-feed/recover pipe 212. In this recovery operation, a flow of the liquid developer and gas from the liquid developer holder 222 to the liquid developer tank 210 via the liquid developer-feed/recover pipe 212 is prevented by the check-valve 227.

Here, in this embodiment, since the concentration of 10%-30% is set to that of nonvolatile components in the liquid developer, and the amount of liquid developer fed to the image-holding device can be reduced, it is possible to compose simple flow paths of the fed and recovered liquid developer.

Moreover, by repeating the relative displacement between the inner chassis 216 and the development unit cover 209, the liquid developer 1 in the liquid developer holder 222 can also be mixed by stirring effects.

Meanwhile, in this embodiment, the liquid developer tank 210, and the supplementary liquid tanks 230 and 231, are contained in the cartridge along with the development devices such as the development roller 228, and the cartridge is detachably held in record equipment. However, the composition of the cartridge according to the present invention is not restricted to the above compositions. For example, it is possible to compose the record equipment such that developing components such as the development roller 228 are fixed to the record equipment, and only the components of; the liquid developer tank 210, and the supplementary liquid tanks 230 and 231; are contained in the cartridge which is held detachably from the record equipment.

As mentioned above, in the embodiment, the following liquid type development device is provided, that is: the liquid type development device which performs developing operations by using liquid developer in which charged toner particles are dispersed, comprising a detachably situated cartridge; and a development roller which can be immersed in liquid developer in a liquid developer-holding device; wherein the cartridge includes a liquid developer tank connected to the liquid developer-holding device, and supplementary liquid tanks filled with supplementary liquid containing nonvolatile components dispersed in the liquid developer.

The above supplementary liquid tanks can be composed of a high concentration supplementary-liquid tank filled with supplementary liquid containing the nonvolatile components of concentration higher than that of the nonvolatile components in the liquid developer, and a low concentration supplementary-liquid tank filled with supplementary liquid containing the nonvolatile components of concentration lower than that of the nonvolatile components in the liquid developer.

Also, as described previously, instead of providing a liquid developer tank and a supplementary liquid tank separately, it is possible to integrate a liquid developer tank and a supplementary liquid tank, and situate an infiltration film between a liquid developer section and a supplementary liquid section.

Moreover, an instrument for measuring the amount of supplementary liquid remaining in each supplementary liquid tank is provided, and record equipment for memorizing the measured amount of remaining supplement liquid is also provided.

FIG. 1 is a schematic block diagram showing the circuit composition of the record equipment of an embodiment according to the present invention.

In this embodiment, reference numbers 100, 200, and 300, indicate the record equipment, the development cartridge situated detachably from the record equipment 100, and a control unit situated in the record equipment 100, respectively.

The development cartridge 200 includes memorizing circuits made of IC chips, used for an ID-memorizing section 201 for memorizing a serial number of each cartridge, a remaining ink amount-memorizing section 202 for memorizing the remaining amount of liquid developer, an ink concentration-memorizing section 203 for memorizing the concentration of nonvolatile components in the liquid developer, a remaining supplementary liquid amount-memorizing section 204 for memorizing the remaining amount of supplementary liquid to be added to the liquid developer so as to keep the concentration of nonvolatile components in the liquid developer constant, a printing information-memorizing section 205 for memorizing printing conditions such as the print ratio of the developed image, and a recycle ratio-memorizing section for memorizing the recycle ratio of liquid in the development cartridge, which is calculated based on the detected remaining amount of supplementary liquid.

If the image printing apparatus using the liquid type development device receives an instruction of printing an image from an external controller 400 such as a personal computer, a print means-controlling section 301 in a control unit 300 controls a print means 101 which is composed of a laser optical system, based on image data 401, a developing device, a fixing device, a paper sheet-carrying system, etc., and the sent image data 401 is printed as a visualized image. Also, a print ratio-calculating section 303 calculates the print ratio of the image based on the sent image data 401. Here, the print ratio is defined as the ratio of an area of a colored region to an area of a whole region in which the printing of each image is performed. An ink concentration-managing means-controlling means 302 calculates the amount of supplementary liquid to be added to liquid developer so as to keep the concentration of nonvolatile components in the liquid developer constant, based on the obtained print ratio, and controls an ink concentration-managing means 102 to supply the calculated amount of supplementary liquid to the liquid developer. In each developing operation, the remaining ink amount, the ink concentration, the remaining supplementary liquid, etc., are memorized in a remaining ink amount-memorizing section in the development cartridge 200. Meanwhile, it is possible to improve the reliability of managing the concentration of ink, by comparing the ink concentration calculated by the control unit 300 with that detected by an ink concentration-detecting section 206, and correcting the ink concentration.

Further, a recycle ratio-calculating section 304 calculates the recycle ratio, and a recycle score point-calculating section 305 calculates the recycle score points based on the calculated recycle ratio. Then, a display means 105 such as a liquid crystal display, displays the calculated recycle score. Here, the recycle ratio is a value corresponding to the ratio of the remaining supplementary-liquid amount to the initial supplementary-liquid amount, and if 30% of the initial amount is not used yet, and is remaining in a supplementary liquid tank, the recycle ratio is fundamentally 30%. However, since the quality of liquid developer may deteriorate as time passes from the production day of the liquid developer, the ratio of remaining supplementary-liquid amount which can be recycled is calculated by considering various conditions, and this calculated recycle ratio is used and displayed. Also, the recycle score points correspond to the discount rate granted to the user of the cartridge when he replaces a new cartridge by purchase, and the recycle score points link to the recycle ratio. In order to prevent vexatious complication of treating the recycle score points, it is preferable to increase the recycle score point in phases as increase of the recycle ratio while rounding a calculated value of the recycle score points.

According to this embodiment, by displaying the recycle ratio corresponding to the remaining amount of supplementary liquid, and making the recycle ratio reflect on the discount rate of price, user's tendency of casting away the remaining supplementary liquid can be suppressed, and user's witting of recycling the remaining supplementary liquid can also be improved.

Meanwhile, by determining a coefficient for calculation of the recycle ratio, which corresponds to the aging easiness of each supplementary liquid, and registering the determined coefficient in the ID-memorizing section 201, it becomes possible to control the feeding of the supplementary liquid while reflecting various improvement which had been implemented for supplementary liquid.

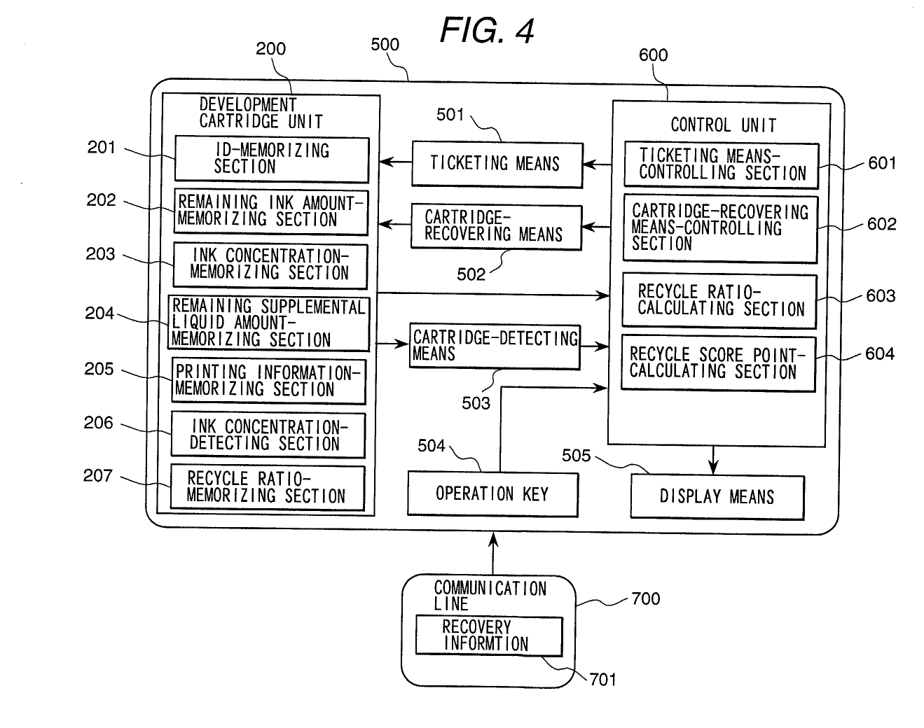

FIG. 4 is a schematic block diagram showing the circuit composition of a recovery means for recovering development cartridges according to the present invention.

When the development cartridge 200 is inserted into a cartridge-recovering box 500, the remaining state of supplementary liquid in the cartridge 200 is recognized by a cartridge state-detecting means 503, and various kinds of information memorized in memory elements in the development cartridge are read out by a control unit 600. Further, a recycle ratio and recycle score points are calculated by a recycle ratio-calculating section 603 and a recycle score point-calculating section 604 based on the read-out information, respectively. A ticketing means 501, which is controlled by a ticketing means-controlling section 601, issues a recycle ticket indicating the recycle score points. In place of issuing a recycle ticket, it is possible to writing the recycle score points in a magnetic card.

The development cartridge 200 inserted into the development cartridge-recovering box 500 is recovered and stored in the development cartridge-recovering box 500 by a cartridge-recovering means 502 controlled by a cartridge-recovering means-controlling means 602. The information read out of the recovered cartridge 200 are transmitted to the maker which fabricated the cartridge 200 or to a recycle company via a communication line 700. Thus, the used and stored cartridge 200 is occasionally recovered, and is recycled.

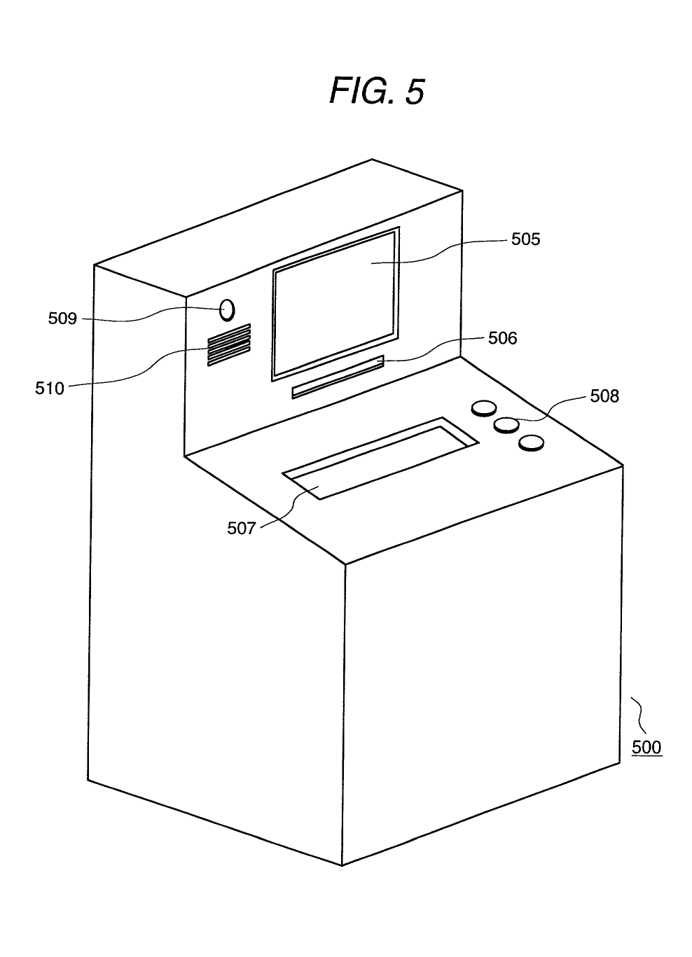

FIG. 5 shows an example of the development cartridge-recovery box 500 implementing the recovery means of the present invention.

A development cartridge-recovering inlet 507 is provided at the development cartridge-recovery box 500, and the development cartridge 200 is inserted into this inlet 507. Operation guidance, a result of calculation, etc., are displayed on a display means 505 such as a liquid crystal display device, and an operator operates an operation panel 508. Also, voice guidance from a speaker 519 is jointly used. Further, behaviors of the operator are taken into by a monitor camera 509, and the intention of the operator is determined by using the taken-in behaviors along with his operations of the operation panel 508.

Next, a method of adjusting the concentration of nonvolatile components in liquid developer is explained below.

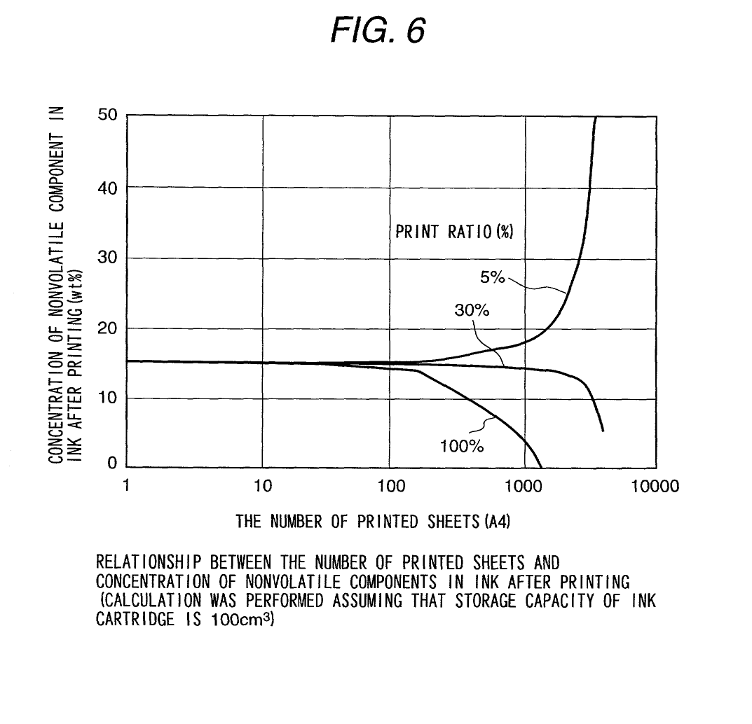

In the liquid type development device of the present invention, in order to use liquid developer efficiently without waste, liquid developer used development operations is recovered and reused. In such a system, many time-development operations changes the concentration of nonvolatile components in the liquid developer depending on the print ratios of developed images as shown in FIG. 6. This is because toner particles are consumed in a colored region, and solvent is consumed in a non-colored region. Accordingly, if many images of large print ratios, which have large colored regions, are continuously developed, the concentration of nonvolatile components decreases. Conversely, if many images of small print ratios, which have small colored regions, are continuously developed, the concentration of nonvolatile components increases. FIG. 6 shows results of calculated changes in the concentration of nonvolatile components assuming that the print ratio is constant, and it is confirmed that the results well agree with results of changes in the concentration of nonvolatile components in printing experiments. Thus, since the concentration of nonvolatile components after printing can be estimated from the print ratio obtained by using the image data of a printed image, the amount of supplementary liquid to be fed can be obtained so as to correct changes in the concentration of nonvolatile components.

In the embodiment shown in FIG. 2, there are two types of supplementary tanks, that is: a high concentration supplementary liquid tank 230 containing supplementary liquid in which the concentration of nonvolatile components is higher than that in the liquid developer, and a low concentration supplementary liquid tank 231 containing supplementary liquid in which the concentration of nonvolatile components is lower than that in the liquid developer. In this way, by preparing two kinds of supplementary liquid, it is possible to keep the concentration of nonvolatile components almost constant by adding supplementary liquid contained in the high concentration supplementary liquid tank 230 to the liquid developer 1 when images of high print ratios are continuously printed, and adding supplementary liquid contained in the low concentration supplementary liquid tank 231 to the liquid developer 1 when images of low print ratios are continuously printed, which in turn can keep the development state stable.

The information such as the remaining amount of supplementary liquid, which is obtained by the control unit 600, is stored in a memorizing device 232 via a terminal 233 for the memorizing device 232.

As mentioned above, the present invention provides a maintenance method of performing maintenance work of a liquid type development device for developing an electrostatic latent image formed on an image-holding device by using liquid developer in which charged toner particles are dispersed, wherein the remaining amount of supplementary liquid used to keep the concentration of nonvolatile components in the liquid developer constant, which is contained in each supplementary liquid tank, is measured and memorized; and the memorized remaining amount of supplementary liquid is displayed when the cartridge containing the supplementary liquid tank is exchanged.

Moreover, when a new cartridge is bought, a discount rate of price of the new cartridge is calculated corresponding to the above remaining amount of supplementary liquid, and the discount rate of price is indicated.

Further, the present invention provides a supplementary liquid-recovery method of recovering supplementary liquid from a liquid type development device for developing an electrostatic latent image formed on an image-holding device by using liquid developer in which charged toner particles are dispersed, including detachable cartridges, in each of which a development roller is immersed in liquid developer held in a liquid developer-holding component, each cartridge containing a liquid develop tank connected to the liquid developer-holding component and at least one supplementary liquid tank filled with supplementary liquid which is nonvolatile components in the liquid developer; wherein the supplementary liquid tank is detachably set in the cartridge, and supplementary liquid remaining in the supplementary liquid tank is recovered by detaching the supplementary liquid tank from the cartridge.

In this supplementary liquid-recovery method also, when a new cartridge is bought, a discount rate of price for the new cartridge is calculated corresponding to the above remaining amount of supplementary liquid, and the discount rate of price is indicated.

Also, when a used development device including the cartridge, the development roller, and the developer-holding component, is recovered, and a new development device is bought, a discount rate of price for the new development device is calculated corresponding to the above remaining amount of supplementary liquid.

Additionally, it is possible to recover high and low concentration liquid separately, from a high concentration supplementary liquid tank 230 containing supplementary liquid in which the concentration of nonvolatile components is higher than that in the liquid developer, and from a low concentration supplementary liquid tank 230 containing supplementary liquid in which the concentration of nonvolatile components is lower than that in the liquid developer.

In accordance with the present invention, it has become possible to provide a liquid type development device which is easily maintained, and from which remaining liquid developer and supplementary liquid are easily recovered. Further, the maintenance of a liquid type development device, and the recover of liquid developer and supplementary liquid, have also become easier by using liquid developer of high concentration, whose evapotranspiration to the air is a little, and for which a recirculation component for controlling its concentration is not necessary; providing a cartridge including the liquid developer and supplementary liquid to be added to the liquid developer so as to keep the concentration of the liquid developer constant; and memorizing the amount of supplementary liquid remaining in the cartridge. Furthermore, by giving a user a special privilege of a discount price for a new development cartridge corresponding to the amount of supplementary liquid remaining in a used development cartridge, the convenience in dealing with a development cartridge can be improved, and user's tendency of casting away the remaining supplementary liquid can be suppressed. In addition, user's witting of recycling the remaining supplementary liquid can be improved, and the efficiency of recovering the remaining supplementary liquid can be improved.

What is claimed is:

1. A liquid type development device for developing an electrostatic latent image formed on image-holding equipment by using liquid developer in which charged toner particles are dispersed, said apparatus comprising:
a detachable cartridge; and
a development roller which is immersed in said liquid developer held in a liquid developer-holding unit situated in said detachable cartridge;
wherein said cartridge further contains a liquid developer tank connected to said liquid developer-holding unit, and at least one supplementary liquid tank filled with supplementary liquid which is non volatile components in said liquid developer.

2. A liquid type development device according to claim 1, wherein said cartridge contains a high concentration supplementary liquid tank containing supplementary liquid which includes nonvolatile components of higher concentration than that of nonvolatile components in said liquid developer, and a low concentration supplementary liquid tank containing supplementary liquid which includes nonvolatile components of lower concentration than that of nonvolatile components in said liquid developer.

3. A liquid type development device according to claim 1, wherein said liquid developer tank and said supplementary liquid tank is integrated into one tank, and liquid developer and supplementary liquid are partitioned at the boundary between said liquid developer and said supplementary liquid by using an infiltration film.

4. A liquid type development device according to claim 1, wherein an instrument for measuring the amount of said supplementary liquid remaining in said supplementary liquid tank is provided at said supplementary liquid tank, and record equipment for memorizing the measured amount of said remaining supplementary liquid is provided.

5. A maintenance method of maintaining a liquid type development device for developing an electrostatic latent image formed on image-holding equipment by using liquid developer in which charged toner particles are dispersed, said method comprising the steps of:
measuring the amount of supplementary liquid remaining in a supplementary liquid tank filled with said supplementary liquid to be added to said liquid developer so as to keep the concentration of nonvolatile components in said liquid developer at a predetermined value;
memorizing said measured amount of said supplementary liquid which remains in said supplementary liquid tank; and
indicating said memorized amount of said supplementary liquid which remains in said supplementary liquid tank when a cartridge containing said supplementary liquid tank is exchanged.

6. A maintenance method according to claim 5, wherein, when a new cartridge is bought, a discount price for said new cartridge is calculated corresponding to said amount of said supplementary liquid which remains in said supplementary liquid tank contained in said exchanged cartridge.

7. A supplementary liquid-recover method of recovering supplementary liquid from a liquid type development device for developing an electrostatic latent image formed on image-holding equipment by using liquid developer in which charged toner particles are dispersed, said liquid type development device including a detachable cartridge, a development roller immersed in liquid developer held in a liquid developer-holding unit situated in said cartridge in which a liquid developer tank and at least one supplementary liquid tank filled with supplementary liquid of nonvolatile components;
wherein said supplementary liquid tank is operated so as to be in a state capable of being detached from said cartridge, and the supplementary liquid remaining in said supplementary liquid tank is recovered by detaching said supplementary liquid tank from said cartridge.

8. A maintenance method according to claim 6, wherein, when a new cartridge is bought, a discount price for said new cartridge is calculated corresponding to said amount of said supplementary liquid remaining in said supplementary liquid tank contained in said exchanged cartridge.

9. A maintenance method according to claim 6, wherein, when used development equipment including said cartridge, said development roller, and said liquid developer-holding unit is recovered, and another new development equipment is bought, a discount price for said new development equipment is calculated corresponding to said amount of said supplementary liquid remaining in said supplementary liquid tank contained in said exchanged cartridge.

10. A liquid type development device according to claim 6, wherein an instrument for measuring the amount of said supplementary liquid remaining in said supplementary liquid tank is provided at said supplementary liquid tank, and record equipment for memorizing the measured amount of said remaining supplementary liquid is provided.

11. A liquid type development device according to claim 6, wherein said cartridge contains a high concentration supplementary liquid tank containing supplementary liquid which includes nonvolatile components of higher concentration than that of nonvolatile components in said liquid developer, and a low concentration supplementary liquid tank containing supplementary liquid which includes nonvolatile components of lower concentration than that of nonvolatile components in said liquid developer.
